(19) United States
(12) Patent Application Publication
(10) Pub. No.: US 2026/0112068 A1
(43) Pub. Date: Apr. 23, 2026

(54) DEEP NEURAL NETWORK BASED IMAGE COMPRESSION USING A LATENT SHIFT BASED ON GRADIENT OF LATENTS ENTROPY

(71) Applicant: InterDigital CE Patent Holdings, SAS, Paris (FR)

(72) Inventors: Muhammet Balcilar, Betton (FR); Bharath Bhushan Damodaran, Vannes (FR); Karam Naser, Mouaze (FR); Thierry Dumas, Rennes (FR)

(21) Appl. No.: 19/113,096

(22) PCT Filed: Sep. 14, 2023
(86) PCT No.: PCT/EP2023/075367

§ 371 Date: Mar. 19, 2025

(30) Foreign Application Priority Data
Sep. 20, 2022 (EP) 22306377.7

(51) Int. Cl. G06T 9/00; H04N 19/91

(52) U.S. Cl. CPC G06T 9/002; H04N 19/91

(57) ABSTRACT

A deep neural network based video compression system in which gradients of entropies with respect to side and main latents are used on decoding side to improve compression efficiency.

### 1. TECHNICAL FIELD

At least one of the present embodiments generally relates to a method and a device for coding and decoding a picture data using a deep neural network and, in particular, a method and a device taking benefit of gradient of latents entropy to improve a compression efficiency.

### 2. BACKGROUND

To achieve high compression efficiency, traditional video compression schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

In recently explored video coding solutions, neural network (NN) based processing has been investigated. Several NN based solutions had been proposed from the hybrid solutions wherein NN are used to implement some tools of the traditional video compression schemes described above to fully NN based compression solutions.

A key aspect of any video (or image) compression solution is to use as much as possible information available on a decoder side to improve compression efficiency. Information available on the decoder side comprises, of course, data explicitly encoded in a bitstream (i.e. in encoded video data), but also data that are not explicitly encoded but that can be inferred from the explicitly encoded video data. Such inferred data were largely used in traditional video compression schemes. However, the fully NN based compression methods are not as mature as the methods based on the traditional video compression scheme. Consequently, the possibility of taking benefit of explicitly encoded data to infer other data is still an aspect to be explored.

It is desirable to determine which data could be inferred from explicitly encoded data available on the decoder side in fully NN based video (or image) compression methods and how using these inferred data to improve the compression efficiency of said fully NN based video compression methods.

### 3. BRIEF SUMMARY

In a first aspect, one or more of the present embodiments provide a method comprising:
obtaining an input picture: applying a deep neural network based encoder to the input picture to obtain main latents: applying a deep hyperprior neural network based encoder to the input picture to obtain side latents: quantizing the side latents to obtain side codes using a first quantization method: applying factorized entropy model to the side codes to determine first probability mass functions of side codes under the first quantization method: arithmetic encoding the side codes based on the first probability mass functions in video data: inverse quantizing the side codes to obtain reconstructed side latents: determining a first step size based on a gradient of side information's entropy with respect to reconstructed side latents: encoding an information representative of the first step size in the video data: shifting the reconstrcuted side latents using the first step size and the gradient of side information's entropy with respect to the reconstructed side latents: applying a deep hyperprior decoder to the shifted reconstructed side latents to obtain the information representative of probability distributions modeling the main latents: obtaining second probability mass functions for main codes using the probability distributions modeling the main latents: quantizing main latents to obtain the main codes; and, arithmetic encoding the main codes based on the second probability mass functions in the video data.

In an embodiment, the method further comprise: inverse quantizing the main codes to obtain reconstructed main latents: determining a second step size based on a gradient of main information's entropy with respect to main latents; and, encoding an information representative of the second step size in the video data.

In a second aspect, one or more of the present embodiments provide a method comprising:
obtaining an input picture: applying a deep neural network based encoder to the input picture to obtain main latents: applying a deep hyperprior neural network based encoder to the input picture to obtain side latents: quantizing the side latents to obtain side codes using a first quantization method: applying factorized entropy model to the side codes to determine first probability mass functions of side codes under the first quantization method: arithmetic encoding the side codes based on the first probability mass functions in video data: inverse quantizing the side codes to obtain reconstructed side latents: applying a deep hyperprior decoder to the shifted reconstructed side latents to obtain information representative of probability distributions modeling the main latents: obtaining second probability mass functions for main codes using the probability distributions modeling the main latents: arithmetic encoding the main codes based on the second probability mass functions in the video data: inverse quantizing the main codes to obtain reconstructed main latents: determining a second step size based on a gradient of main information's entropy with respect to main latents; and, encoding an information representative of the second step size in the video data.

In a third aspect, one or more of the present embodiments provide a method comprising:
applying an arithmetic decoding to side information comprised in video data to obtain side codes using first probability mass functions provided by a factorized entropy model: inverse quantizing to the side codes to obtain reconstructed side latents: decoding an information representative of a first step size based on a gradient of side information's entropy with respect to reconstructed side latents: shifting the reconstructed side latents using the first step size and the gradient of side information's entropy with respect to the reconstructed side latents: applying a deep hyperprior decoder to the shifted reconstructed side latents to obtain an information representative of probability distributions modeling the main latents: obtaining a second probability mass functions for main codes using the probability distributions modeling the main latents: arithmetic decoding main codes from the video data using the second probability mass function: inverse quantizing main codes to obtain reconstructed main latents; and, applying a deep neural network based decoder to the reconstructed main latents to obtain an output picture.

In an embodiment, the method further comprise: decoding an information representative of a second step size based on a gradient of main information's entropy with respect to main latents from the video data; and, shifting the reconstructed main latents using the second step size and the gradient of main information's entropy with respect to the main latents, the deep neural network based decoder being applied on the shifted reconstructed main latents.

In a fourth aspect, one or more of the present embodiments provide a method comprising:
applying an arithmetic decoding to side information comprised in video data to obtain side codes using first probability mass functions provided by a factorized entropy model: inverse quantizing the side codes to obtain reconstructed side latents: applying a deep hyperprior decoder to the reconstructed side latents to obtain an information representative of probability distributions modeling the main latents; obtaining second probability mass functions for main codes using the probability distributions modeling the main latents: arithmetic decoding main codes from the video data using the second probability mass function: inverse quantizing main codes to obtain reconstructed main latents: decoding an information representative of a second step size based on a gradient of main information's entropy with respect to main latents from the video data: shifting the reconstructed main latents using the second step size and the gradient of main information's entropy with respect to the main latents; and, applying a deep neural network based decoder to the shifted reconstructed main latents to obtain an output picture.

In a fifth aspect, one or more of the present embodiments provide a device comprising electronic circuitry configured for:
obtaining an input picture;
applying a deep neural network based encoder to the input picture to obtain main latents;
applying a deep hyperprior neural network based encoder to the input picture to obtain side latents;
quantizing the side latents to obtain side codes using a first quantization method;
applying factorized entropy model to the side codes to determine first probability mass functions of side codes under the first quantization method;
arithmetic encoding the side codes based on the first probability mass functions in video data;
inverse quantizing the side codes to obtain reconstructed side latents;
determining a first step size based on a gradient of side information's entropy with respect to reconstructed side latents;
encoding an information representative of the first step size in the video data;
shifting the side latents using the first step size and the gradient of side information's entropy with respect to the reconstructed side latents;
applying a deep hyperprior decoder to the shifted reconstructed side latents to obtain the information representative of probability distributions modeling the main latents;
obtaining second probability mass functions for main codes using the probability distributions modeling the main latents;
quantizing main latents to obtain the main codes; and,
arithmetic encoding the main codes based on the second probability mass functions in the video data.

In an embodiment, the electronic circuitry is further configured for:
inverse quantizing the main codes to obtain reconstructed main latents;
determining a second step size based on a gradient of main information's entropy with respect to main latents; and,
encoding an information representative of the second step size in the video data.

In a sixth aspect, one or more of the present embodiments provide a device comprising electronic circuitry configured for:
obtaining an input picture;
applying a deep neural network based encoder to the input picture to obtain main latents;
applying a deep hyperprior neural network based encoder to the input picture to obtain side latents;
quantizing the side latents to obtain side codes using a first quantization method;
applying factorized entropy model to the side codes to determine first probability mass functions of side codes under the first quantization method;
arithmetic encoding the side codes based on the first probability mass functions in video data;
inverse quantizing the side codes to obtain reconstructed side latents;
applying a deep hyperprior decoder to the shifted reconstructed side latents to obtain an information representative of probability distributions modeling the main latents;
obtaining second probability mass functions for main codes using the probability distributions modeling the main latents;
arithmetic encoding the main codes based on the second probability mass functions in the video data.
inverse quantizing the main codes to obtain reconstructed main latents;
determining a second step size based on a gradient of main information's entropy with respect to main latents; and,
encoding an information representative of the second step size in the video data.

In a seventh aspect, one or more of the present embodiments provide a device comprising electronic circuitry configured for:
applying an arithmetic decoding to side information comprised in video data to obtain side codes using first probability mass functions provided by a factorized entropy model;
inverse quantizing the side codes to obtain reconstructed side latents;
decoding an information representative of a first step size based on a gradient of side information's entropy with respect to reconstructed side latents;
shifting the reconstructed side latents using the first step size and the gradient of side information's entropy with respect to the reconstructed side latents;
applying a deep hyperprior decoder to the shifted reconstructed side latents to obtain an information representative of probability distributions modeling the main latents;
obtaining second probability mass functions for main codes using the probability distributions modeling the main latents;
arithmetic decoding main codes from the video data using the second probability mass function;
inverse quantizing main codes to obtain reconstructed main latents; and,
applying a deep neural network based decoder to the reconstructed main latents to obtain an output picture.

In an embodiment, the electronic circuitry is further configured for:
decoding an information representative of a second step size based on a gradient of main information's entropy with respect to main latents from the video data; and,
shifting the reconstructed main latents using the second step size and the gradient of main information's entropy with respect to the main latents, the deep neural network based decoder being applied on the shifted reconstructed main latents.

In a eighth aspect, one or more of the present embodiments provide a device comprising electronic circuitry configured for:
applying an arithmetic decoding to side information comprised in video data to obtain side codes using first probability mass functions provided by a factorized entropy model;
inverse quantizing the side codes to obtain reconstructed side latents;
applying a deep hyperprior decoder to the reconstructed side latents to obtain an information representative of probability distributions modeling the main latents;
obtaining second probability mass functions for main codes using the probability distributions modeling the main latents;
arithmetic decoding main codes from the video data using the second probability mass function;
inverse quantizing main codes to obtain reconstructed main latents;
decoding an information representative of a second step size based on a gradient of main information's entropy with respect to main latents from the video data;
shifting the reconstructed main latents using the second step size and the gradient of main information's entropy with respect to the main latents; and,
applying a deep neural network based decoder to the shifted reconstructed main latents to obtain an output picture.

In a ninth aspect, one or more of the present embodiments provide a computer program comprising program code instructions for implementing the method according to the first, second, third, fourth, fifth or sixth aspect.

In a tenth aspect, one or more of the present embodiments provide a non-transitory information storage medium storing program code instructions for implementing the method according to the first, second, third, fourth, fifth or sixth aspect.

In a eleventh aspect, one or more of the present embodiments provide a signal produced by the method of the first, second or third aspect or by the device of the seventh, eighth or ninth aspect.

### 4. BRIEF SUMMARY OF THE DRAWINGS

FIG. 1 illustrates schematically a context in which embodiments are implemented;

FIG. 2A illustrates schematically an example of hardware architecture of a processing module able to implement an encoding module or a decoding module in which various aspects and embodiments are implemented;

FIG. 2B illustrates a block diagram of an example of a first system in which various aspects and embodiments are implemented;

FIG. 2C illustrates a block diagram of an example of a second system in which various aspects and embodiments are implemented;

FIG. 3 illustrates the training phase of a deep NN based video compression system;

FIG. 4 illustrates a video encoder based on a trained deep NN based video compression system;

FIG. 5 illustrates a video decoder based on a trained deep NN based video compression system;

FIG. 6 illustrates a video encoding process based on a trained deep NN based video compression system of an embodiment; and,

FIG. 7 illustrates a video decoding process based on a trained deep NN based video compression system of an embodiment.

### 5. DETAILED DESCRIPTION

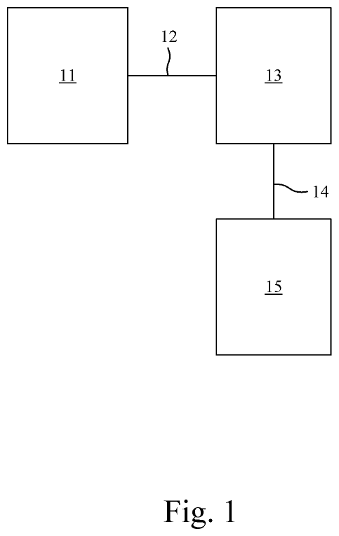

FIG. 1 illustrates schematically a context in which embodiments are implemented.

In FIG. 1, a system 11, that could be a camera, a storage device, a computer, a server or any device capable of delivering a video data, transmits video data to a system 13 using a communication channel 12. The video data are either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video data to generate a sequence of decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display 15 are comprised in a TV, a computer, a tablet, a smartphone, a head-mounted display, etc.

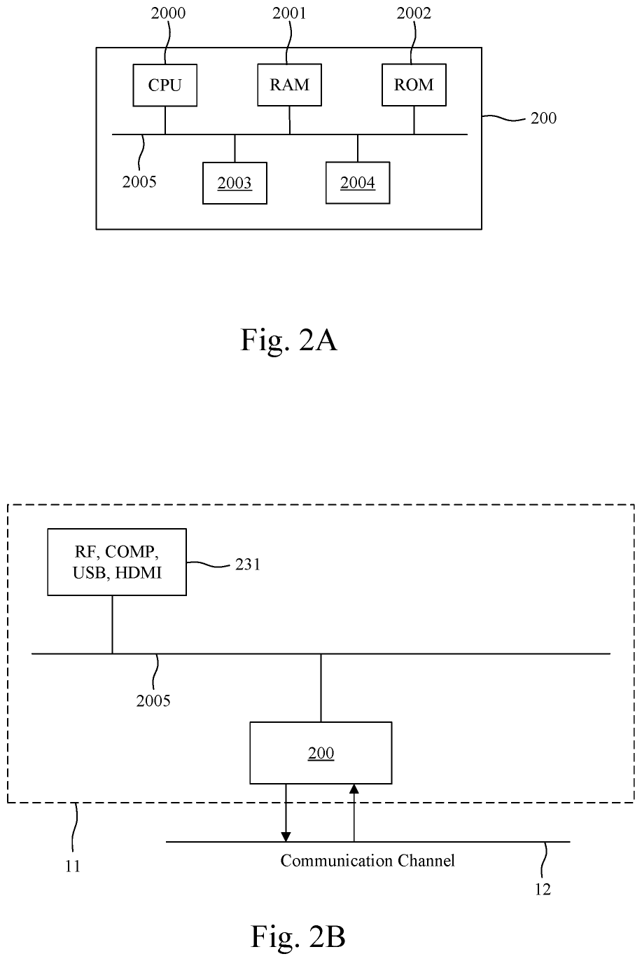

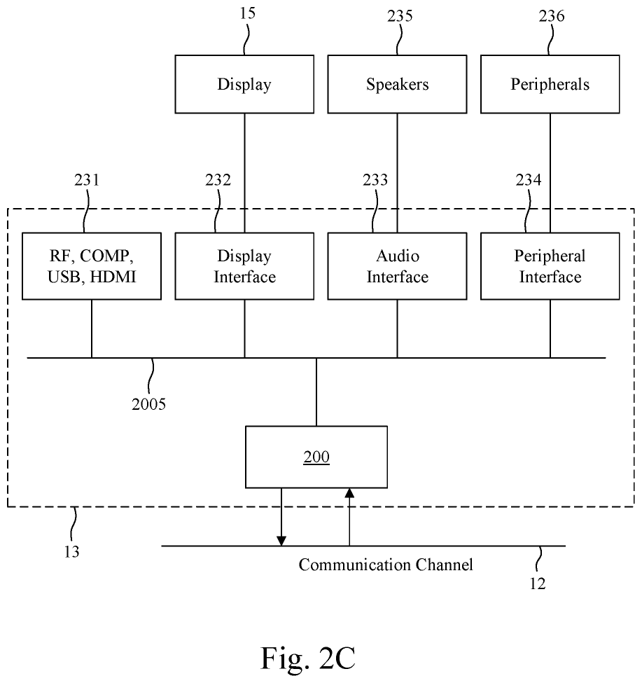

FIGS. 2A, 2B and 2C describes examples of device, apparatus and/or system allowing implementing the various embodiments.

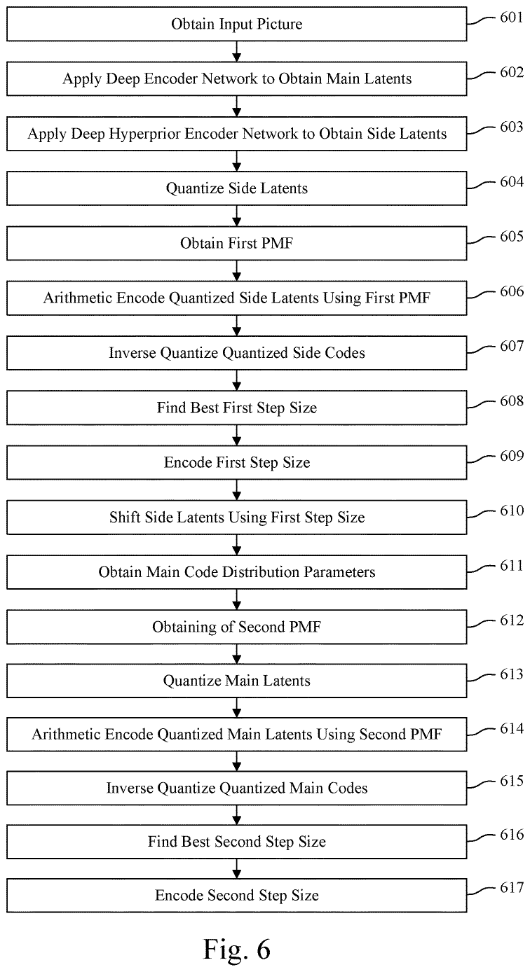

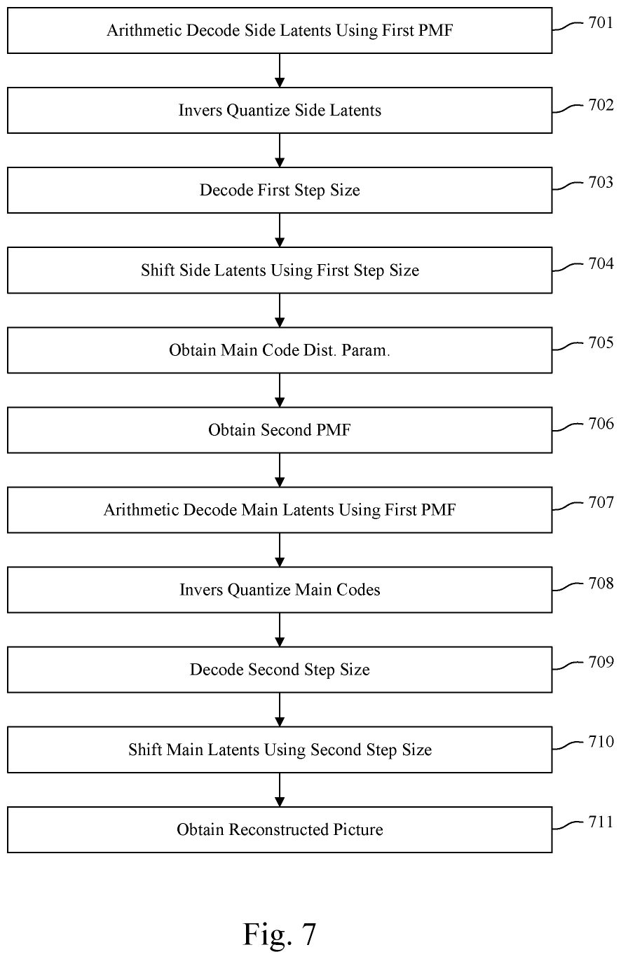

FIG. 2A illustrates schematically an example of hardware architecture of a processing module 200 able to implement an encoding module or a decoding module capable of implementing respectively a method for encoding of FIG. 6 and a method for decoding of FIG. 7. The encoding module is for example comprised in the system 11 when this system is in charge of encoding the video data. The decoding module is for example comprised in the system 13.

The processing module 200 comprises, connected by a communication bus 2005: a processor or CPU (central processing unit) 2000 encompassing one or more microprocessors, general purpose computers, special purpose computers, and processors based on a multi-core architecture, as non-limiting examples: a random access memory (RAM) 2001: a read only memory (ROM) 2002: a storage unit 2003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device: at least one communication interface 2004 for exchanging data with other modules, devices or system. The communication interface 2004 can include, but is not limited to, a transceiver configured to transmit and to receive data over a communication channel. The communication interface 2004 can include, but is not limited to, a modem or network card.

If the processing module 200 implements a decoding module, the communication interface 2004 enables for instance the processing module 200 to receive encoded video data and to provide a sequence of decoded pictures. If the processing module 200 implements an encoding module, the communication interface 2004 enables for instance the processing module 200 to receive a sequence of original pictures to encode and to provide encoded video data.

The processor 2000 is capable of executing instructions loaded into the RAM 2001 from the ROM 2002, from an external memory (not shown), from a storage medium, or from a communication network. When the processing module 200 is powered up, the processor 2000 is capable of reading instructions from the RAM 2001 and executing them. These instructions form a computer program causing, for example, the implementation by the processor 2000 of a decoding method as described in relation with FIG. 7 and/or an encoding method described in relation to FIG. 6.

All or some of the algorithms and steps of the methods of FIGS. 6 and 7 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted to implement at least partially the methods of FIGS. 6 and 7.

FIG. 2C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 200 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 200 can be provided through various input modules as indicated in block 231. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 2C, include composite video.

In various embodiments, the input modules of block 231 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal. (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 200 as necessary. Similarly, aspects of USB or HDMI interface processing can be implemented within separate interface ICs or within the processing module 200 as necessary. The demodulated, error corrected, and demultiplexed stream is provided to the processing module 200.

Various elements of system 13 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 13, the processing module 200 is interconnected to other elements of said system 13 by the bus 2005.

The communication interface 2004 of the processing module 200 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 2004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 231. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 235, and other peripheral devices 236. The display system 15 of various embodiments includes one or more of, for example, a touchscreen display, an organic light-emitting diode (OLED) display, a curved display, and/or a foldable display. The display system 15 can be for a television, a tablet, a laptop, a cell phone (mobile phone), a head mounted display or other devices. The display system 15 can also be integrated with other components (for example, as in a smart phone), or separate (for example, an external monitor for a laptop). The other peripheral devices 236 include, in various examples of embodiments, one or more of a stand-alone digital video disc (or digital versatile disc) (DVR, for both terms), a disk player, a stereo system, and/or a lighting system. Various embodiments use one or more peripheral devices 236 that provide a function based on the output of the system 13. For example, a disk player performs the function of playing an output of the system 13.

In various embodiments, control signals are communicated between the system 13 and the display system 15, speakers 235, or other peripheral devices 236 using signaling such as AV.Link, Consumer Electronics Control (CEC), or other communications protocols that enable device-to-device control with or without user intervention. The output devices can be communicatively coupled to system 13 via dedicated connections through respective interfaces 232, 233, and 234. Alternatively, the output devices can be connected to system 13 using the communications channel 12 via the communications interface 2004 or a dedicated communication channel corresponding to the communication channel 12 in FIG. 2C via the communication interface 2004. The display system 15 and speakers 235 can be integrated in a single unit with the other components of system 13 in an electronic device such as, for example, a television. In various embodiments, the display interface 232 includes a display driver, such as, for example, a timing controller (T Con) chip.

The display system 15 and speaker 235 can alternatively be separate from one or more of the other components. In various embodiments in which the display system 15 and speakers 235 are external components, the output signal can be provided via dedicated output connections, including, for example, HDMI ports, USB ports, or COMP outputs.

FIG. 2B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 200 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 200 can be provided through various input modules as indicated in block 231 already described in relation to FIG. 2C.

Various elements of system 11 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 11, the processing module 200 is interconnected to other elements of said system 11 by the bus 2005.

The communication interface 2004 of the processing module 200 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 2004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 231.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, etc. In various embodiments, these data are raw data provided for example by a picture and/or audio acquisition module connected to the system 11 or comprised in the system 11. In that case, the processing module 200 takes in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on received video data in order to produce a final output suitable for display. In various embodiments, such processes include a deep neural network based decoding process and a deep hyperprior neural network based decoding process.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce encoded video data. In various embodiments, such processes include a deep neural network based encoding process and a deep hyperprior neural network based encoding process.

Whether the phrase “encoding process” is intended to refer specifically to a subset of operations or generally to the broader encoding process will be clear based on the context of the specific descriptions and is believed to be well understood by those skilled in the art.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion tradeoff. In particular, during a training of a deep NN based compression method, the balance or trade-off between a rate and a distortion is usually considered. The rate distortion optimization is usually formulated as minimizing a rate distortion function, which is a weighted sum of the rate and of the distortion. NN based compression method have trainable parameters to be found by gradient based optimization and hyperparameters to be defined initially. There are different approaches to find these hyperparameters to minimize the rate distortion optimization problem. For example, the approaches may be based on an extensive testing of all deep neural network parameters values, with a complete evaluation of their coding cost and related distortion on a reconstructed signal after coding and decoding. Faster approaches may also be used, to save computation complexity, in particular with computation of an approximated distortion based on a prediction or a prediction residual signal, not the reconstructed one. Mix of these two approaches can also be used, such as by using an approximated distortion for only some of the possible deep NN network parameters, and a complete distortion for other deep NN network parameters. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals parameters or steps sizes. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video data of a described embodiment. Such a signal can be formatted, for example, as an electromagnetic wave (for example, using a radio frequency portion of spectrum) or as a baseband signal. The formatting can include, for example, encoding video data and modulating a carrier with the encoded video data. The information that the signal carries can be, for example, analog or digital information. The signal can be transmitted over a variety of different wired or wireless links, as is known. The signal can be stored on a processor-readable medium.

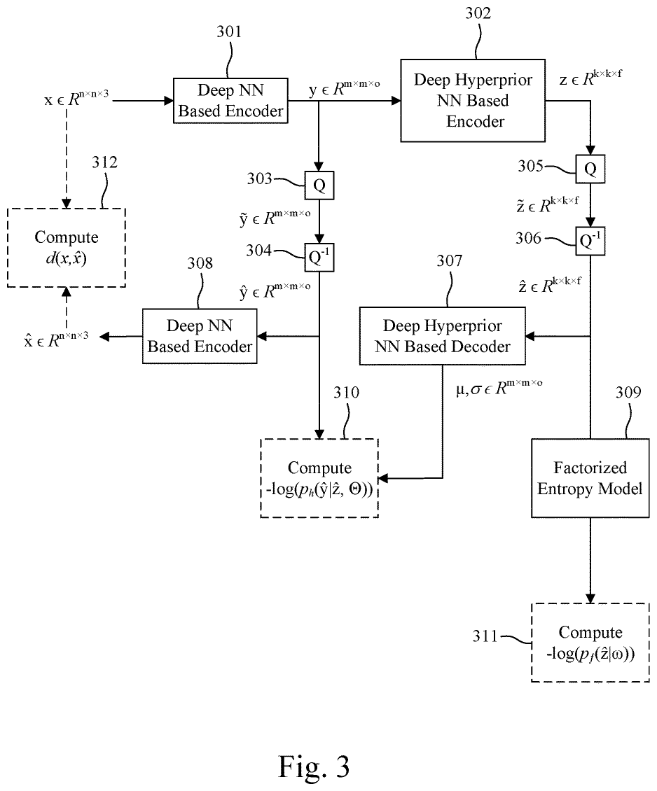

FIG. 3 illustrates the training phase of a deep NN based video compression system.

The training phase of FIG. 3 is for example executed by the processing module 200.

In a step 301, the processing module 200 applies a deep NN based encoding gₐ to an input picture x∈R^{n×n×3} of size n×n with three components. Outputs y (with y∈R^{m×m×o}) of the deep NN based encoding are called main latents (or main embeddings) of the input picture x.

In a step 303, the processing module 200 applies a quantization Q(.) to the main latents y to obtain main codes \tilde{y} of the input picture x (\tilde{y}=Q(y)). For example, in the process of FIG. 3, the quantization is a scalar quantization.

In a step 304, the processing module 200 applies an inverse quantization (Q⁻¹( )) to the main codes \tilde{y} to obtain reconstructed main latents ŷ (ŷ=Q⁻¹(\tilde{y})).

In a step 302, the processing module 200 applies a deep hyperprior NN based encoding hₐ to the main latents y to obtain side latents (or side embeddings) z, with z∈R^{k×k×f}. The deep hyperprior NN based encoding hₐ is based on an hyperprior entropy model Pₕ.

In a step 305, the processing module 200 applies a quantization (Q( )) to the side latents z to obtain side codes \tilde{z}.

In a step 306, the processing module 200 applies an inverse quantization (Q⁻¹( )) to the side codes \tilde{z} to obtain reconstructed side latents \tilde{z}.

The reconstructed side latents \hat{z} can be used to learn a probability model of the reconstructed main latents ŷ. Typically, the reconstructed main latents ŷ can be modelled by Gaussian distributions the parameters (i.e. the mean μ and the standard deviation σ) of which are obtained by a deep hyperprior NN based decoder hₛ.

In a step 307, the processing module 200 applies the deep hyperprior decoder hₛ to the reconstructed side latents \hat{z} to obtain the parameters of the Gaussian distributions modeling the main latents ŷ.

In a step 308, the processing module 200 applies a deep NN based decoder gₛ to the reconstructed main latents ŷ to obtain a reconstructed picture \hat{x}, \hat{x}∈R^{n×n×3}.

In the training phase illustrated in FIG. 3, a lower bound of bitlength of side codes \tilde{z} can be calculated using a factorized entropy model p_{f}. The factorized entropy model allows learning a probability density function (PDF) of the side codes \tilde{z} from the reconstructed side latents \hat{z}. Using this PDF, a probability mass function (PMF) of each side code \tilde{z} under a known quantization method (here a scalar quantization) can be calculated. One can note that a PMF is an integral of a PDF from one border of a quantization range to the other border of the quantization range (provided that the quantization is a scalar quantization). PMF values are enough to calculate the lower bound of bitlength of side codes \tilde{z}. One can note that PMF can be represented by tables, called PMF tables.

In a step 309, the processing module 200 applies the factorized entropy model p_{f} to the reconstructed side latents \hat{z} to determine the lower bound of bitlength BL_{\tilde{z}} of side codes \tilde{z} (BL_{\tilde{z}}=−log(p_{f}(\hat{z}|ω)), p_{f}(\hat{z}|ω) being directly obtained from the PMF (or PMF tables). We show below that the lower bound of bitlength BL_{\tilde{z}} of side codes \tilde{z} is used as a first rate information in a rate distortion optimization allowing training model parameters. One can note that the PMF obtained from the factorized entropy model p_{f} are considered as learned PMF since they depend on a learned model.

On another hand, a lower bound of bitlength of the main codes \tilde{y} can be calculated using the hyperprior entropy model Pₕ. This model is usually implemented by a Gaussian distribution. Basically, each reconstructed main latent (ŷᵢ) in ŷ is supposed to follow a Gaussian distribution where the parameters (μᵢ, σᵢ) are obtained using side information \hat{z} (or \tilde{z} since there is a direct connection between \hat{z} and \tilde{z}) in previous step. PMF of the Gaussian distribution can be obtained based on these parameters (μᵢ, σᵢ) and a known quantization method. The parameters (μᵢ, σᵢ) are considered as learned parameters since they are dependent on the hyperprior entropy model Pₕ which is a learned model. Similarly, the PMF of the Gaussian distributions are considered as learned PMF. Thus, these Gaussian's PMF are enough to calculate the lower bound of bitlength of main codes.

In a step 310, the processing module 200 uses the learned Gaussian's PMF to determine the lower bound of bitlength BL_{\tilde{z}} of main codes \tilde{y} as follows:

$${BL}_{\tilde{y}} = - log ( {p}_{h} ( \hat{y} \vert \hat{z} , Θ ) )$$

Indeed, pₕ(ŷ|\hat{z}, Θ) is directly obtained from the learned Gaussian's PMF.

We show below that the lower bound of bitlength BL_{\tilde{y}} of main codes \tilde{y} is used as a second rate information in a rate distortion optimization allowing training model parameters.

In the process of FIG. 3, the deep NN based encoding gₐ (or (gₐ(.; φ))), the deep NN based decoding gₛ (or (gₛ(.; θ))), the deep hyperprior NN based encoding hₐ (or (hₐ(.; Φ))), the deep hyperprior NN based decoding hₛ (or hₛ(.; Θ)) and the factorized entropy model p_{f} (or p_{f}(.; ω) are composed of multiple NN layers, such as convolutional layers. Each NN layer can be described as a function that first multiply an input by a tensor, add a vector called a bias and then apply a nonlinear function on resulting values. A shape (and other characteristics) of the tensor and a type of non-linear functions are called the architecture of the network. We denote values of the tensor and the bias by the term weights. The weights and, if applicable, the parameters of the non-linear functions, are called the parameters. The architecture and the parameters define a model. The parameters of the models used in the deep NN based encoding gₐ (or (gₐ(.; φ))), the deep NN based decoding gₛ (or (gₛ(.; θ))), the deep hyperprior NN based encoding hₐ (or (hₐ(.; Φ))), the deep hyperprior NN based decoding hₛ (or hₛ(.; Θ)) and the factorized entropy model p_{f} (or p_{f}(.; ω) are denoted respectively by φ, θ, Φ, Θ and ω.

A model must be trained on massive databases D of pictures to learn its parameters. Typically, the model's parameters are optimized to minimize a training loss LOSS represented in equation (eq. 1).

$$LOSS = {E}_{x \sim D} [ - log ( {p}_{f} ( \hat{z} \vert ω ) ) - log ( {p}_{h} ( \hat{y} \vert \hat{z} , Θ ) ) + λ d ( x , \hat{x} ) ] , \qquad ( eq . 1 )$$

where d (.,.) measures a distortion between the input picture and the reconstructed picture (for example d (.,.) is a mean square error). In equation (eq. 1), a rate term is a sum of the lower bound of bitlength of the side information BL (i.e. −log(p_{f}(\hat{z}|ω))) and the lower bound of bitlength of the main information BL_{\tilde{y}} (i.e. −log(pₕ(ŷ|\hat{z}, Θ))). Hyperparameter λ controls the trade-off between the rate term and the distortion term.

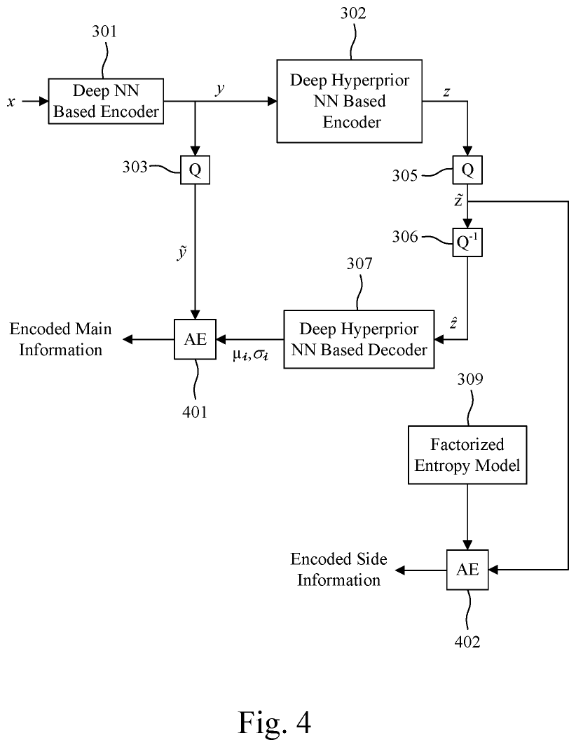

FIG. 4 illustrates a video encoding process based on a trained deep NN based video compression system.

For example, the trained deep NN based video compression system is the one of FIG. 3 (i.e. the deep NN based video compression system with the parameters φ, θ, Φ, Θ and ω with the method of FIG. 3). The video encoding process is for example executed by the processing module of system 11. In FIG. 4, we keep the same reference numbers for steps that were already described in relation to FIG. 3.

In step 301, the processing module 200 applies the deep NN based encoding gₐ to the input picture x.

In step 303, the processing module 200 applies the quantization Q(.) to the main latents y to obtain the main codes \tilde{y}.

In step 302, the processing module 200 applies the deep hyperprior NN based encoding hₐ to the main latents y to obtain the side latents z.

In step 305, the processing module 200 applies a quantization to the side latents z to obtain the side codes \tilde{z}.

In step 306, the processing module 200 applies an inverse quantization to the side codes \tilde{z} to obtain the reconstructed side latents \hat{z}.

As already mentioned above, the reconstructed side latents \hat{z} are used to obtain a (Gaussian) probability model of the reconstructed main latents ŷ. In a step 307, the processing module 200 applies the deep hyperprior decoder hₛ to the reconstructed side latents \hat{z} to obtain the parameters (μᵢ, σᵢ) of the Gaussian distributions modeling the main latents ŷ. Learned PMF (represented by learned PMF tables) are then derived from the Gaussian distribution modeling the main latents ŷ.

In a step 401, the processing module 200 applies an arithmetic encoding (AE) to the main codes \tilde{y} to obtain encoded main information and inserts the encoded main information in video data (i.e. in an encoded video stream). The AE uses the learned PMF tables provided by the deep hyperprior NN based decoder in step 307.

In a step 309, the processing module 200 applies the factorized entropy model p_{f} to the side codes \tilde{z} to determine learned PMF tables of each side code \tilde{z} under the known quantization method.

In a step 402, the processing module 200 applies an AE to the side codes \tilde{z} to obtain encoded side information and insert the encoded side information in video data (i.e. in an encoded video stream). The AE of step 402 is driven by the learned PMF tables computed in step 309.

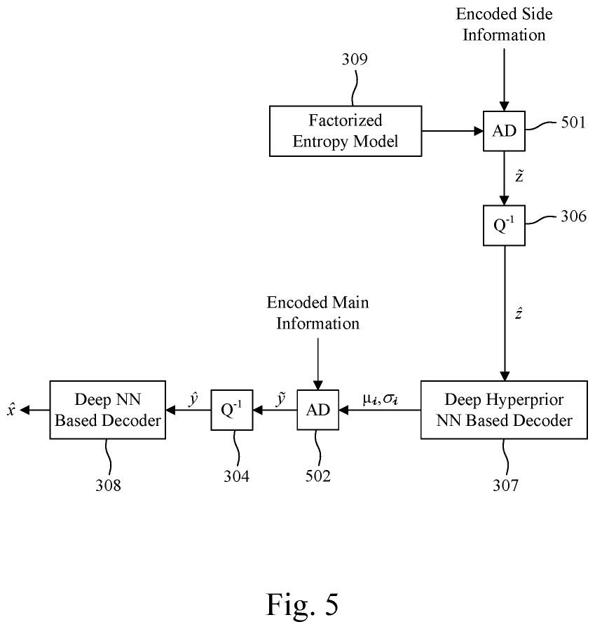

FIG. 5 illustrates a video decoder based on a trained deep NN based video compression system.

For example, the trained deep NN based video compression system is the one of FIG. 3 (i.e. the deep NN based video compression system with the parameters, θ, θ, Θ and ω with the method of FIG. 3). The video decoding process is for example executed by the processing module of system 13. In FIG. 5, we keep the same reference numbers for steps that were already described in relation to FIG. 3.

In a step 501, the processing module 200 applies an arithmetic decoding (AD) to side information comprised in the video data (i.e. in the encoded video stream) to obtain side codes using learned PMF tables provided by the factorized entropy model in step 309.

In step 306, the processing module 200 applies an inverse quantization to the side codes \tilde{z} to obtain the reconstructed side latents \hat{z}.

In step 307, the processing module 200 applies the deep hyperprior decoder hₛ to the reconstructed side latents \hat{z} to obtain the parameters (μᵢ, σᵢ) of the Gaussian distributions modeling the main latents ŷ and derives learned PMF (in the form of learned PMF tables) from these Gaussian distributions.

In a step 502, the processing module 200 applies an AD to the encoded main information contained in the video data using the learned PMF determined in step 307. These distributions (and the learned PMF tables) indicates to the AD how to read main codes from bitstream.

In step 304, the processing module 200 applies an inverse quantization to the main codes \tilde{y} to obtain reconstructed main latents ŷ.

In step 308, the processing module 200 applies the deep NN based decoding gₛ to the reconstructed main latents ŷ to obtain a reconstructed picture.

As evocated in introduction of the present document, a purpose of the following embodiments is to investigate which data could be inferred from explicitly encoded data available on a decoding side in a deep NN based video compression method (also called fully NN based video compression method) and how using these inferred data to improve the compression efficiency of said deep NN based video compression method.

One first example of data that could be inferred from explicitly encoded data comprised in video data is a gradient of side information's entropy with respect to the reconstructed side latents \hat{z}. This gradient noted ∇_{\hat{z}}(−log(p_{f}(\hat{z}|ω))) can be easily computed on a decoding side. This gradient can give an idea about how to change the reconstructed side latents \hat{z} in order to increase or decrease their entropy.

One second example of data that could be inferred from explicitly encoded data comprised in video data is a gradient of main information's entropy with respect to the reconstructed main latents ŷ. This gradient noted ∇_{ŷ}(−log(pₕ(ŷ|\hat{z}, Θ))) also can be easily computed on a decoding side. This gradient can give an idea about how to change the main latents ŷ in order to increase or decrease their entropy.

So far, these two gradients remain unused in the literature of deep NN based video compression methods.

In the following embodiments, these gradients of the entropies with respect to side and main latents are used on decoding side to improve compression efficiency. These embodiments takes benefit of correlation existing between these two gradients and other useful gradients.

More specifically, in these embodiments, it is shown that:
The gradient of the side information's entropy with respect (w.r.t.) to the reconstructed side latents \hat{z} is correlated with a gradient of a main information's entropy w.r.t \hat{z}. Thus, after obtaining the reconstructed side latents \hat{z}, an approximation of the gradient of the main information's entropy w.r.t \hat{z} can be derived, thus the side latents can be shifted by a first step size according to approximated gradient to decrease bitlength of main information.
The gradient of main information's entropy w.r.t the reconstructed main latents ŷ is correlated with a gradient of a reconstruction quality between the input picture x and the output picture \hat{x} (measured by d(x, \hat{x})) w.r.t the reconstructed main latents ŷ. Thus, after obtaining the reconstructed main latents ŷ, an approximation of the gradient of the reconstruction quality w.r.t the reconstructed main latents ŷ can be derived. Thus, the main latents can be shifted by a second step size according to this approximated gradient in order to increase reconstruction quality.

In the following, best first and second step sizes are found on encoding side and the two step sizes are encoded in the video data so that they can be used in the decoding process.

In the following we give some definitions, remarks and theorem allowing clarifying the various embodiments.

State of the art deep NN based video compression methods generally use the loss function represented by equation (eq. 1). This loss function can be seen as an unconstrainted multi-objectives optimization problem wherein the objectives are minimum bitlength of side information (−log(p_{f}(\hat{z}|ω))), minimum bitlength of main information (−log(pₕ(ŷ|\hat{z}, Θ))) and minimum reconstruction error (λd(x, \hat{x})).

Following definition gives an idea on what the optimal solution of the multi-objective optimization would be:
Definition: Pareto Optimal solution is an optimal solution where no objective can be made better off without making at least one objective worse off. By using different importance weights for objectives, we can get different solutions. If these solutions are Pareto Optimal, they create a curve named Pareto Frontier curve.

Thus, the aim of the multi-objective optimization is to find pareto optimal points on the Pareto Frontier curve where different points on the curve are obtained by a given weighting term λ. In equation (eq. 1), there is no reason to privilege the first bitlength term (i.e. minimum bitlength of side information (−log(p_{f}(\hat{z}|ω)))) or the second bitlength term (i.e. minimum bitlength of main information (−log(pₕ(ŷ|\hat{z}, Θ)))). These two bitlength terms having equal importance, their coefficient can be seen as 1. But λ results the optimizer producing different solutions. If all these solutions are Pareto Optimal, these solutions are located on the Pareto Frontier curve. This curve is generally named rate-distortion curve in the image/video compression domain.

The following remark shows a useful property of a solution of unconstrainted multi-objective optimization problems:
Remark: A solution of the multi-objective optimization problem is Pareto Optimal, if and only if it satisfies Karush-Kuhn-Tucker (KKT) conditions. More specifically, in unconstrainted multi-objective optimization problems case, if the aim of the problem is:

$${w}^{*} = {arg min}_{w} ( {Σ}_{i} {α}_{i} {ℒ}_{i} ( w ) )$$

Where αᵢ≥0 and Σᵢαᵢ=1 and [symbol] ᵢ the objective functions, the solution w* is Pareto Optimal if and only if it satisfies the following.

$${\sum }_{i} {α}_{i} {∇}_{w} {ℒ}_{i} ( {w}^{*} ) = 0$$

In other words, the remark indicates that, on an optimal solution point, all objectives' gradients should be in a fight, and no one could not win anything more. All forces driven by gradients cancel each other out and the solution reaches a saddle point. This property is used to test the optimality of candidate solutions.

This remark is also valid for end-to-end compression models. Following theorem shows how to use KKT conditions for an end-to-end video compression system such as the deep NN based compression system of FIGS. 3 and 4.

Theorem: An end-to-end compression model optimized with λ trade-off is Pareto Optimal, if and only if the following two conditions are met.

$${E}_{x \sim D} [ {∇}_{\hat{z}} ( - log ( {p}_{f} ( \hat{z} \vert ω ) ) ) + {∇}_{\hat{z}} ( - log ( {p}_{h} ( \hat{y} \vert \hat{z} , Θ ) ) ) ] = 0 \qquad ( eq . 2 )$$

$${E}_{x \sim D} [ {∇}_{\tilde{y}} ( - log ( {p}_{h} ( \hat{y} \vert \hat{z} , Θ ) ) ) + λ . {∇}_{\tilde{y}} ( d ( x , \hat{x} ) ) ] = 0 \qquad ( eq . 3 )$$

### Proof:

In order to show the resemblance between end-to-end loss and unconstrainted multi-objective optimization loss, we can re-write the loss as follows:

$$\frac{Loss}{2 + λ} = {E}_{x \sim D} [ \frac{1}{2 + λ} \times - log ( {p}_{f} ( \hat{z} \vert ω ) ) + \frac{1}{2 + λ} \times - log ( {p}_{h} ( \hat{y} \vert \hat{z} , Θ ) ) + \frac{λ}{2 + λ} \times d ( x , \hat{x} ) ] ,$$

Here,

$${α}_{1} = \frac{1}{2 + λ} , {α}_{2} = \frac{1}{2 + λ} and {α}_{3} = \frac{λ}{2 + λ} ,$$

since λ>0, ∨i, αᵢ>0 and

$${\sum }_{i} {α}_{i} = \frac{2 + λ}{2 + λ} = 1 ,$$

thus αᵢ satisfy to be the unconstrainted multi-objective optimization's coefficients. Since we do not target to change the parameters of the end-to-end model, but just target to adjust main and side latents \hat{z}, ŷ, we keep all the parameter fixed, but \hat{z}, ŷ as variable. Thus we can write side information's bitlength objective with [symbol] ₁(\hat{z})=−log(p_{f}(\hat{z}|ω)), main information's bitlength objective with [symbol] ₂(ŷ,\hat{z})=−log(pₕ(ÿ|\hat{z}, Θ)) and finally distortion objective with [symbol] ₃(x, ŷ)=d(x, gₛ(ŷ; θ)). Thus, the model can be written as an unconstrained multi objective optimization problem.

$${\hat{z}}^{*} , {\hat{y}}^{*} = {arg min}_{\hat{z} , \hat{y}} ( {E}_{x \sim D} [ {α}_{1} {ℒ}_{1} ( \hat{z} ) + {α}_{2} {ℒ}_{2} ( \hat{y} , \hat{z} ) + {α}_{3} {ℒ}_{3} ( x , \hat{y} ) ] )$$

Since this problem has two sets of variables to be optimized, both variables should meet KKT conditions. The variable \hat{z} does not have any effect on [symbol] ₃(ŷ), thus ∇_{\hat{z}} [symbol] ₃(ŷ)=0. We can write KKT condition for \hat{z} as follows:

$${E}_{x \sim D} [ {α}_{1} {∇}_{\hat{z}} {ℒ}_{1} ( \hat{z} ) + {α}_{2} {∇}_{\hat{z}} {ℒ}_{2} ( \hat{y} , \hat{z} ) ] = 0$$

Since α₁=α₂ they cancel themselves out, we reach the first condition in equation (eq. 2) in the theorem if we replace the [symbol] ₁(\hat{z}) and [symbol] ₂(ŷ, \hat{z}) with their definitions.

The second variable ŷ does not have any effect on [symbol] ₁(\hat{z}), thus ∇_{ŷ} [symbol] ₁(\hat{z})=0. We can write KKT condition for ŷ as follows:

$${E}_{x \sim D} [ {α}_{2} {∇}_{\hat{y}} {ℒ}_{2} ( \hat{y} , \hat{z} ) + {α}_{3} {∇}_{\hat{y}} {ℒ}_{3} ( \hat{y} ) ] = 0$$

If we replace the objectives by their definitions and divide the two-hand side by α₂, and

$$\frac{{α}_{3}}{{α}_{2}} = λ ,$$

we reach the second condition in the theorem in equation (eq. 3).

The proof is straight-forward and almost trivial. But the result of this theorem is significant. The above theorem can be interpreted as if one of the existed end-to-end models is optimal (at least in terms of training procedure, not in terms of compressing performance), gradient of side information's entropy w.r.t side latents ∇_{\hat{z}}(−log(p_{f}(\hat{z}|ω))) and gradient of main information's entropy w.r.t side latents ∇_{\hat{z}}(−log(pₕ(ŷ|\hat{z}, Θ))) can cancel themselves out in expectation. It is the same for the second condition as well. We can claim that main information's entropy w.r.t main latents ∇_{ŷ}(−log(pₕ(ŷ|\hat{z}, Θ))) and weighted gradient of reconstruction error w.r.t main latents λ. ∇_{ŷ}(d(x, \hat{x})) can cancel themselves out in expectation. But equation (eq. 2) and (eq. 3) would be zero in average of all train set, not any given single specific picture. Thus, their sum may not be exact zero for a given single picture.

The following hypothesis is important for the following embodiment:

Hypothesis: We assume that all existed end-to-end video compression models are trained well, and their solution is Pareto Optimal. The sum of the gradients in the theorem are zero for training set, also they are correlated for a given single picture.

To verify the above hypothesis, the correlations of the pair of gradients in the theorem are calculated. Tests have shown that the correlation between gradients in equation (eq. 2) is not that clear for a given single picture, and thus affects the performance weakly. However, for the latter case of equation (eq. 3), the correlation is quite clear. These test results motivate a use of gradients available on the decoding side as proxy for useful gradients which are unknown on the decoding side.

If the side latents \hat{z} is shifted by ∇_{\hat{z}}(−log(pₕ(ŷ|\hat{z}, Θ))), it decreases the main information's bitlength because the gradients indicates how to shift \hat{z} in order to decrease −log(pₕ(ŷ|\hat{z}, θ)) by definition. However, ∇_{\hat{z}}(−log(pₕ(ŷ|\hat{z}, Θ))) is not available in decoding device. Since we show that ∇_{\hat{z}}(−log(p_{f}(\hat{z}|ω))) and ∇_{\hat{z}}(−log(pₕ(ŷ|\hat{z}, Θ))) are correlated, we use the available gradient ∇_{\hat{z}}(−log(p_{f}(\hat{z}|ω))) as proxy of the gradient ∇_{\hat{z}}(−log(pₕ(ŷ|\hat{z}, Θ))) in a first proposal:
Proposal 1. After decoding side codes and obtaining reconstructed side latents \hat{z}, if we shift ź by

$${ρ}_{f}^{*} {∇}_{\hat{z}} ( - log ( {p}_{f} ( \hat{z} \vert ω ) ) ) ,$$

there is a real number step size

$${ρ}_{f}^{*}$$

that decrease the bitlength of main information such that:

$$- log ( {p}_{h} ( \hat{y} \vert \hat{z} , Θ ) ) \geq - log ( {p}_{h} ( \hat{y} \vert \hat{z} + {ρ}_{f}^{*} {∇}_{\hat{z}} ( - log ( {p}_{f} ( \hat{z} \vert ω ) ) ) , Θ ) ) \qquad ( eq . 4 )$$

ρ_{f} can be found by brutal force out of handful candidates or any optimization method to find optimal one such that:

$${ρ}_{f}^{*} = {arg min}_{{ρ}_{f}} ( - log ( {p}_{h} ( \hat{y} \vert \hat{z} + {ρ}_{f} {∇}_{\hat{z}} ( - log ( {p}_{f} ( \hat{z} \vert ω ) ) ) , Θ ) ) ) \qquad ( eq . 5 )$$

In addition, if we shift the main latents ŷ, by ∇_{ŷ}(d(x, gₛ(ŷ; θ))), it decreases the reconstruction error because the gradients indicates how to shift ŷ in order to decrease d(x, gₛ(ŷ; θ)) by definition. However, ∇_{ŷ}(d(x, gₛ(ŷ; θ))) is not available in decoding device. Since we show that ∇_{ŷ}(−log(pₕ(ŷ|\hat{z}, Θ))) and ∇_{ŷ}(d(x, gₛ(ŷ; θ))) are correlated, we again use the available gradient ∇_{ŷ}(−log(pₕ(ŷ|\hat{z}, Θ))) as proxy of the gradient ∇_{ŷ}(d(x, gₛ(ŷ; θ))) in a second proposal:
Proposal 2. After decoding main codes and obtaining reconstructed main latents ŷ, if we shift ŷ by

$${ρ}_{h}^{*} {∇}_{\hat{y}} ( - log ( {p}_{h} ( \hat{y} \vert \hat{z} , Θ ) ) ) ,$$

there is a real number step size

$${ρ}_{h}^{*}$$

that decrease the reconstruction error such that:

$$d ( x , {g}_{s} ( \hat{y} ; θ ) ) \geq d ( x , {g}_{s} ( \hat{y} + {ρ}_{h}^{*} {∇}_{\hat{y}} ( - log ( {p}_{h} ( \hat{y} \vert \hat{z} , Θ ) ) ) ; θ ) ) \qquad ( eq . 6 )$$

ρₕ can be found by brutal force out of handful candidates or any optimization method to find optimal one such that:

$${ρ}_{h}^{*} = {arg min}_{{ρ}_{h}} ( d ( x , {g}_{s} ( \hat{y} + {ρ}_{h} {∇}_{\hat{y}} ( - log ( {p}_{h} ( \hat{y} \vert \hat{z} , Θ ) ) ) ; θ ) ) ) \qquad ( eq . 7 )$$

In the following embodiment, proposals 1 and 2 can be implemented together or alone.

In an embodiment, finding a best step size is done by identifying a best step size out of some predefined candidate list of step sizes or running a non-linear optimization to find a best step size starting with pₕ=p_{f}=0.

FIG. 6 illustrates a video encoding process based on a trained deep NN based video compression system of an embodiment.

The process of FIG. 6 is based on proposals 1 and 2. This process is for example executed by the processing module 200 of the system 11.

In a step 601, the processing module 200 obtain an input picture x.

In a step 602, identical to step 301, the processing module 200 applies the deep NN based encoding gₐ to the input picture x to obtain main latents y.

In a step 603, identical to step 302, the processing module 200 applies the deep hyperprior NN based encoding hₐ to the main latents y to obtain the side latents z.

In a step 604, identical to step 305, the processing module 200 applies a quantization to the side latents z to obtain the side codes \tilde{z}.

In a step 605, identical to step 309, the processing module 200 applies the factorized entropy model p_{f} to the side codes \tilde{z} to determine learned PMF tables.

In a step 606, identical to step 402, the processing module 200 applies an AE to the side codes \tilde{z} to obtain encoded side information and insert the encoded side information in video data. The AE of step 402 is driven by the learned PMF tables computed in step 309.

In a step 607, identical to step 306, the processing module 200 applies an inverse quantization to the side codes \tilde{z} to obtain the reconstructed side latents \hat{z}.

In a step 608, the processing module 200 determines a best first step size

$${ρ}_{f}^{*}$$

based on the gradient of side information's entropy w.r.t reconstructed side latents ∇_{\hat{z}}(−log(p_{f}(\hat{z}|ω))) as follows:

$${ρ}_{f}^{*} = {arg min}_{{ρ}_{f}} ( - log ( {p}_{h} ( \hat{y} \vert \hat{z} + {ρ}_{f} {∇}_{\hat{z}} ( - log ( {p}_{f} ( \hat{z} \vert ω ) ) ) , Θ ) ) )$$

In a step 609, the processing module 200 encodes an information representative of the first step size

$${ρ}_{f}^{*}$$

in the video data. The first step size indicates how shifting the side latents.

In a step 610, the processing module 200 shifts the side latents using the first step size

$${ρ}_{f}^{*}$$

and the gradient or side information's entropy w.r.t the reconstructed side latents ∇_{\hat{z}}(−log(p_{f}(\hat{z}|ω))) as follows:

$$\hat{z} = \hat{z} + {ρ}_{f}^{*} {∇}_{\hat{z}} ( - log ( {p}_{f} ( \hat{z} \vert ω ) ) )$$

In a step 611, the processing module 200 applies the deep hyperprior decoder hₛ to the shifted reconstructed side latents \hat{z} to obtain the parameters of the Gaussian distributions modeling the main latents ŷ.

In a step 612, the processing module 200 obtains learned PMF of main codes using the Gaussian distributions modeling the main latents ŷ.

In a step 613, identical to step 303, the processing module 200 applies the quantization Q(.) to the main latents y to obtain the main codes \tilde{y}.

In a step 614, the processing module 200 applies an AE to the main codes \tilde{y} to obtain encoded main information and inserts the encoded main information in the video data. The AE uses the learned PMF tables provided by the deep hyperprior NN based decoder in step 612.

In a step 615, identical to step 304, the processing module 200 applies an inverse quantization to the main codes \tilde{y} to obtain reconstructed main latents ŷ.

In a step 616, the processing module 200 determines a best second step size

$${ρ}_{h}^{*}$$

based on the gradient of main information's entropy w.r.t main latents ∇_{ŷ}(−log(pₕ(ŷ|\hat{z}, Θ))) as follows:

$${ρ}_{h}^{*} = {arg min}_{{ρ}_{h}} ( d ( x , {g}_{s} ( \hat{y} + {ρ}_{h} {∇}_{\hat{y}} ( - log ( {p}_{h} ( \hat{y} \vert \hat{z} , Θ ) ) ) ; θ ) ) )$$

In a step 617, the processing module 200 encodes an information representative of the second step size

$${ρ}_{h}^{*}$$

in the video data. The second step size indicates how shifting the main latents.

In FIG. 6, steps related to the first proposal are steps 608, 609 and 610 and steps related to the second proposal are steps 615, 616 and 617. FIG. 6 represents an embodiment in which proposals 1 and 2 are implemented.

If proposal 1 only is implemented, steps 615, 616 and 617 are skipped.

If proposal 2 only is implemented, steps 608, 609 and 610 are skipped, step 611 using the reconstructed side latents \hat{z} instead of the shifted reconstructed side latents \hat{z}.

FIG. 7 illustrates a video decoding process based on a trained deep NN based video compression system of an embodiment.

The process of FIG. 7 is based on proposal 1 and 2. This process is for example executed by the processing module 200 of the system 13.

In a step 701, identical to step 501, the processing module 200 applies an arithmetic decoding (AD) to side information comprised in the video data to obtain side codes using learned PMF tables provided by the factorized entropy model in step 309.

In a step 702, identical to step 306, the processing module 200 applies an inverse quantization to the side codes \tilde{z} to obtain the reconstructed side latents \hat{z}.

In a step 703, the processing module 200 decodes an information representative of the first step size

$${ρ}_{f}^{*}$$

from the video data.

In a step 704, the processing module 200 shifts the side latents using the first step size

$${ρ}_{f}^{*}$$

and the gradient of side information's entropy w.r.t the side latents ∇_{\hat{z}}(−log(p_{f}(\hat{z}|ω)) as follows:

$$\hat{z} = \hat{z} + {ρ}_{f}^{*} {∇}_{\hat{z}} ( - log ( {p}_{f} ( \hat{z} \vert ω ) ) )$$

In a step 705, the processing module 200 applies the deep hyperprior decoder hₛ to the shifted side latents \hat{z} to obtain the parameters of the Gaussian distributions modeling the main latents ŷ.

In a step 706, the processing module 200 obtains learned PMF (in the form of learned PMF tables) of main codes using the Gaussian distributions modeling the main latents ŷ.

In a step 707, identical to step 502, the processing module 200 applies an AD to the encoded main information contained in the video data using the learned PMF tables determined in step 706.

In a step 708, identical to step 304, the processing module 200 applies an inverse quantization to the main codes \tilde{y} to obtain reconstructed main latents ŷ.

In a step 709, the processing module decodes an information representative of the second step size

$${ρ}_{h}^{*}$$

from the video data.

In a step 710, the processing module 200 shifts the main latents using the second step size

$${ρ}_{h}^{*}$$

and the gradient of the main information's entropy w.r.t the main latents ∇_{\tilde{y}}(−log(pₕ(|ŷ|\hat{z}, Θ))) as follows:

$$\hat{y} = \hat{y} + {ρ}_{h}^{*} {∇}_{\hat{y}} ( - log ( {p}_{h} ( \hat{y} \vert \hat{z} , Θ ) ) )$$

In a step 711, the processing module 200 applies the deep NN based decoding gₛ to the shifted reconstructed main latents ŷ to obtain a reconstructed picture.

In FIG. 6, steps related to the first proposal are steps 703 and 704 and steps related to the second proposal are steps 709 and 710. FIG. 7 represents an embodiment in which proposals 1 and 2 are implemented.

If proposal 1 only is implemented, steps 709 and 710 are skipped step 711 using reconstructed main latents ŷ instead of the shifted reconstructed main latents ŷ.

If proposal 2 only is implemented, steps 703 and 704 are skipped, step 705 using the reconstructed side latents \hat{z} instead of the shifted reconstructed side latents \hat{z}.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described main information, side information and first step size and/or second step size, or variations thereof.
Creating and/or transmitting and/or receiving and/or decoding a bitstream or signal that includes one or more of the described main information, side information and first step size and/or second step size, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.
A server, camera, cell phone, tablet or other electronic device that transmits (e.g. using an antenna) a signal over the air that includes an encoded video stream, and performs at least one of the embodiments described.
A server, camera, cell phone, tablet or other electronic device that tunes (e.g. using a tuner) a channel to transmit a signal including an encoded video stream, and performs at least one of the embodiments described.

1. A method comprising:
obtaining an input picture;
applying a deep neural network based encoder to the input picture to obtain main latents;
applying a deep hyperprior neural network based encoder to the main latents to obtain side latents;
quantizing the side latents to obtain side codes using a first quantization method;
applying a factorized entropy model to the side codes to determine first probability mass functions of side codes under the first quantization method;
arithmetic encoding the side codes based on the first probability mass functions in video data;
inverse quantizing the side codes to obtain reconstructed side latents;
determining a first step size based on a gradient of side information's entropy with respect to reconstructed side latents;
encoding an information representative of the first step size in the video data;
shifting the reconstructed side latents using the first step size and the gradient of side information's entropy with respect to the reconstructed side latents;
applying a deep hyperprior decoder to the shifted reconstructed side latents to obtain information representative of probability distributions modeling the main latents;
obtaining second probability mass functions for main codes using the probability distributions modeling the main latents;
quantizing main latents to obtain the main codes; and,
arithmetic encoding the main codes based on the second probability mass functions in the video data.

2. The method of claim 1 further comprising:
inverse quantizing the main codes to obtain reconstructed main latents;
determining a second step size based on a gradient of main information's entropy with respect to main latents; and,
encoding an information representative of the second step size in the video data.

3. (canceled)

4. A method comprising:
applying an arithmetic decoding to side information comprised in video data to obtain side codes using first probability mass functions provided by a factorized entropy model;
inverse quantizing to the side codes to obtain reconstructed side latents;
decoding an information representative of a first step size based on a gradient of side information's entropy with respect to reconstructed side latents;
shifting the reconstructed side latents using the first step size and the gradient of side information's entropy with respect to the reconstructed side latents;
applying a deep hyperprior decoder to the shifted reconstructed side latents to obtain an information representative of probability distributions modeling main latents;
obtaining second probability mass functions for main codes using the probability distributions modeling the main latents;
arithmetic decoding main codes from the video data using the second probability mass function;
inverse quantizing main codes to obtain reconstructed main latents; and,
applying a deep neural network based decoder to the reconstructed main latents to obtain an output picture.

5. The method of claim 4 comprising:
decoding an information representative of a second step size based on a gradient of main information's entropy with respect to the main latents from the video data; and,
shifting the reconstructed main latents using the second step size and the gradient of main information's entropy with respect to the main latents, the deep neural network based decoder being applied on the shifted reconstructed main latents.

6. (canceled)

7. A device comprising electronic circuitry configured for:
obtaining an input picture;
applying a deep neural network based encoder to the input picture to obtain main latents;
applying a deep hyperprior neural network based encoder to the main latents to obtain side latents;
quantizing the side latents to obtain side codes using a first quantization method;
applying factorized entropy model to the side codes to determine first probability mass functions of side codes under the first quantization method;
arithmetic encoding the side codes based on the first probability mass functions in video data;
inverse quantizing the side codes to obtain reconstructed side latents;
determining a first step size based on a gradient of side information's entropy with respect to reconstructed side latents;
encoding an information representative of the first step size in the video data;
shifting the reconstructed side latents using the first step size and the gradient of side information's entropy with respect to the reconstructed side latents;
applying a deep hyperprior decoder to the shifted reconstructed side latents to obtain information representative of probability distributions modeling the main latents;
obtaining second probability mass functions for main codes using the probability distributions modeling the main latents;
quantizing main latents to obtain the main codes; and,
arithmetic encoding the main codes based on the second probability mass functions in the video data.

8. The device of claim 7 wherein the electronic circuitry is further configured for:
inverse quantizing the main codes to obtain reconstructed main latents;
determining a second step size based on a gradient of main information's entropy with respect to main latents; and,
encoding an information representative of the second step size in the video data.

9. (canceled)

10. A device comprising electronic circuitry configured for:
applying an arithmetic decoding to side information comprised in video data to obtain side codes using first probability mass functions provided by a factorized entropy model;
inverse quantizing the side codes to obtain reconstructed side latents;
decoding an information representative of a first step size based on a gradient of side information's entropy with respect to reconstructed side latents;
shifting the reconstructed side latents using the first step size and the gradient of side information's entropy with respect to the reconstructed side latents;
applying a deep hyperprior decoder to the shifted reconstructed side latents to obtain an information representative of probability distributions modeling the main latents;
obtaining second probability mass functions for main codes using the probability distributions modeling the main latents;
arithmetic decoding main codes from the video data using the second probability mass function;
inverse quantizing main codes to obtain reconstructed main latents; and,
applying a deep neural network based decoder to the reconstructed main latents to obtain an output picture.

11. The device of claim 10 wherein the electronic circuitry is further configured for:
decoding an information representative of a second step size based on a gradient of main information's entropy with respect to main latents from the video data; and,
shifting the reconstructed main latents using the second step size and the gradient of main information's entropy with respect to the main latents, the deep neural network based decoder being applied on the shifted reconstructed main latents.

12-13. (canceled)

14. Non-transitory information storage medium storing program code instructions for implementing the method according to claim 1.

15. (canceled)

16. Non-transitory information storage medium storing program code instructions for implementing the method according to claim 2.

17. Non-transitory information storage medium storing program code instructions for implementing the method according to claim 4.

18. Non-transitory information storage medium storing program code instructions for implementing the method according to claim 5.
